(19) United States
(12) Patent Application Publication
(10) Pub. No.: US 2013/0047840 A1
(43) Pub. Date: Feb. 28, 2013

(54) Light Impact Unit for an Impact Assembly and Impact Assemby

(71) Applicant: Kun Ta Lee, New Taipei City (TW)

(72) Inventor: Kun Ta Lee, New Taipei City (TW)

(21) Appl. No.: 13/444,957

(22) Filed: Apr. 12, 2012

(30) Foreign Application Priority Data
Aug. 22, 2011 (TW) 100129930

(51) Int. Cl. F16J 1/00

(52) U.S. Cl. 92/172

(57) ABSTRACT

A light impact unit for an impact assembly and an impact assembly are disclosed. The light impact unit includes an impact portion, a piston element, a transmission element and a driving portion. The impact portion includes a cavity in which the piston element is disposed. The transmission element has a first end and a second end which is opposite to the first end. The first end and the second end are connected to the piston element and the driving portion respectively. Therefore, when the driving portion provides an impact force intermittently through the transmission element to the piston element, the piston element will impact the impact portion and move in a reciprocating motion.

This application claims the benefit from the priority of Taiwan Patent Application No. 100129930 filed on Aug. 22, 2011, the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention relates to a light impact unit, and more particularly, to a light impact unit for an impact assembly.

2. Descriptions of the Related Art

With the advancement of the science and technologies, products in the market are developing towards integrated and miniaturized designs. To cater to this trend, the technologies of the products must not only be advanced but also be reliable to the structural strength, assembly quality and service life of the products. The designs and planning of the products can also be optimized according to the test data given by the reliability test. Accordingly, reliability tests have become increasingly important in the manufacturing and planning of technology-intensive products.

Conventional reliability tests are mainly impact tests. FIG. 1 shows an impact assembly 1 for a common reliability test. The impact assembly 1 comprises a driving portion 12 and a vibrating platform 14. The driving portion 12, which is fixed below the vibrating platform 14, comprises a cavity 122 and an impact generating unit 124. The impact generating unit 124 impacts back and forth within the cavity 122, therefore the vibrating platform 14 can be driven by the driving portion 12 and move in a reciprocating motion. Then, the user can carry out a reliability test on the object by simply mounting the object on the vibrating platform 14. However, such an impact assembly 1 has a shortcoming in that, while applying a reciprocating motion, the impact generating unit 124 tends to degrade and shortens the overall service life of the impact generating unit 124. Furthermore, in a conventional impact assembly 1, when an impact force is generated, the driving portion 12 has to drive the weights of the vibrating platform 14, the object and itself, which increases the energy loss of the driving portion 12.

Accordingly, it is important to provide an impact assembly that has a longer service life and can decrease the driven weight so that the required energy output is reduced to lower the product testing cost.

### SUMMARY OF THE INVENTION

An objective of the present invention is to provide a light impact generator, while another objective of the present invention is to provide an impact generator in which an impact portion and a driving portion are disposed separately to prolong the service life of the whole impact generator.

To achieve the aforesaid objectives, the present invention provides a light impact unit, which comprises an impact portion, a piston element, a transmission element and a driving portion. The impact portion has a cavity, while the piston element is disposed in the cavity. The transmission element has a first end and a second end opposite to the first end. The first end is connected to the piston element, while the second end is connected to the driving portion. The driving portion provides an impact force intermittently through the transmission element to the piston element so that the piston element is driven to move in a reciprocating motion in the cavity to impact the impact portion.

The present invention further provides an impact assembly, which comprises a platform, a bracket, at least two elastic elements, and at least one light impact unit described above. The bracket is disposed in parallel at a side of the platform. Either the first end or the second end of each of the elastic elements is connected and fixed to the platform, while the other end is connected and fixed to the bracket. The impact portion of the light impact unit is fixed to the platform. While the impact portion moves in a reciprocating motion under the action of the impact force, the platform is synchronously driven by the impact portion of the light impact unit and move in a reciprocating motion.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of an impact assembly of the prior art;

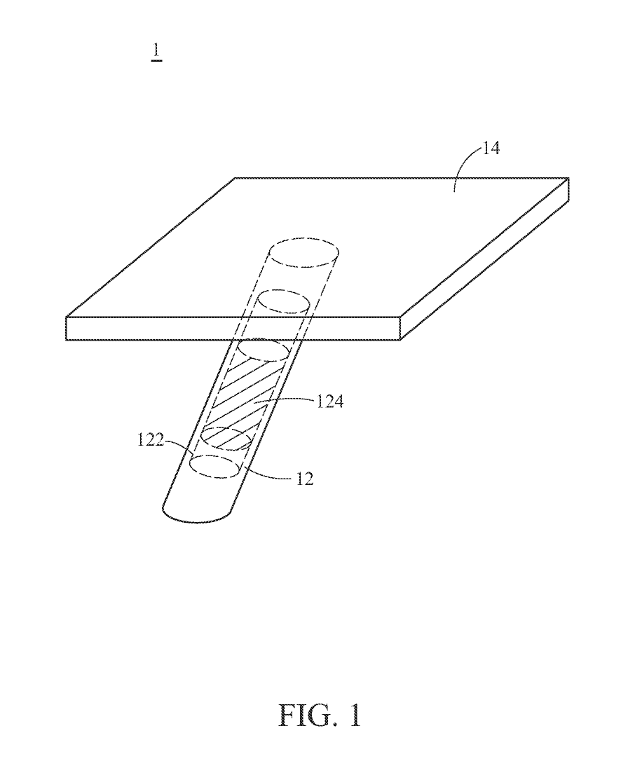

FIG. 2 is a schematic view of a light impact unit according to a first embodiment of the present invention;

FIG. 3 is a schematic view of an impact assembly according to the first embodiment of the present invention;

FIG. 4 is a schematic view of an impact assembly according to a second embodiment of the present invention;

FIG. 5 is a schematic view of an impact assembly according to a third embodiment of the present invention;

FIG. 6 is a schematic view of an impact assembly according to a fourth embodiment of the present invention;

FIG. 7 is a top view of an embodiment of an impact assembly with a plurality of impact units according to the present invention; and

FIG. 8 is a perspective view of an embodiment of another impact assembly with a plurality of impact units according to the present invention.

### DESCRIPTION OF THE PREFERRED EMBODIMENT

The present invention provides a light impact unit in which a driving portion is separated from an impact portion. Hereinbelow, the preferred embodiments of the present invention will be described with reference to appended drawings.

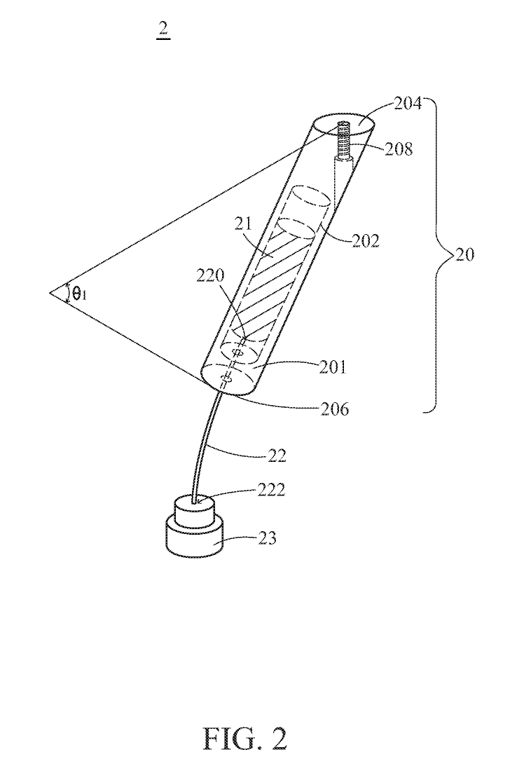

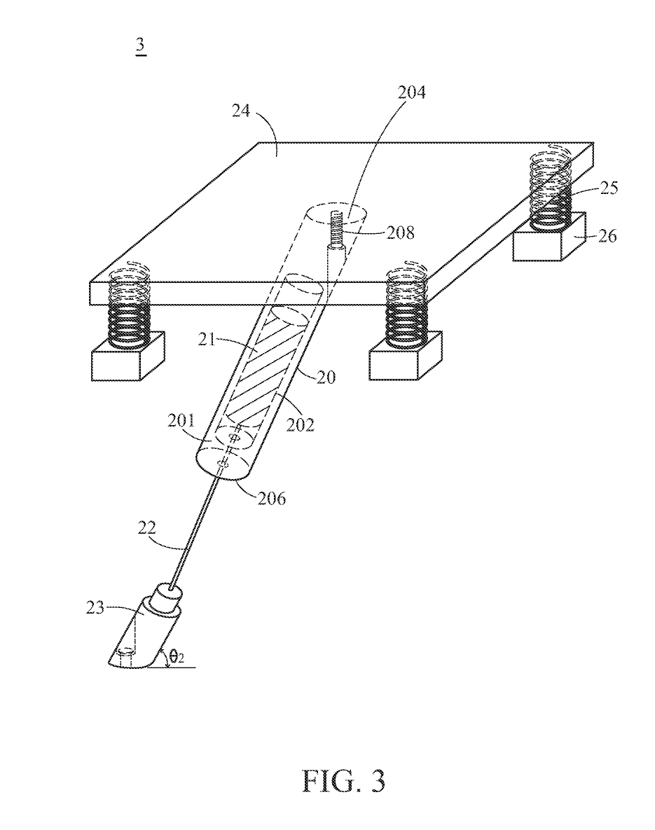

FIG. 2 illustrates a light impact unit 2 according to the first embodiment of the present invention, which comprises an impact portion 20, a piston element 21, a transmission element 22 and a driving portion 23. The impact portion 20 has a housing 201 and a cavity 202 defined inside the housing 201, while the piston element 21 is disposed in the cavity 202. In this embodiment, by threading a screw (not shown) through a hole 208 formed on a top part of the housing 201, the impact portion 20 is fixed to a platform 24 (referring to FIG. 3) or directly fixed to an object for testing (not shown). In practical operation, the driving portion 23 provides an impact force intermittently via the transmission element 22 to the piston element 21 so that the piston element 21 could impact the cavity 202. The impact portion 20 is then driven in a reciprocating motion. Therefore, the platform 24 or the object undergoing testing is correspondingly driven into a reciprocating motion; nevertheless the vibrations are transmitted to the object. It shall be appreciated that although the impact portion 20 in this embodiment is fixed to the platform 24 or to the object undergoing testing with a screw, the present invention is not limited to the use of a screw. In other embodiments, the impact portion may also be fixed to the platform or to the object undergoing testing by other means such as snap-fitting, joining or the like.

Furthermore, the impact portion 20 comprises a first inclined surface 204 and a second inclined surface 206 opposite to the first inclined surface 204, while the first inclined surface 204 and the second inclined surface 206 are placed at two ends of the impact portion 20 respectively. The inclined surfaces 204, 206 extend to define a first included angle θ₁, which ranges between 0 degree and 90 degrees. By changing the incline angle of the first included angle θ₁, different impacting directions can be provided. The light impact units could be made in a variety of different angles; users can apply specific impact unit(s) according to different situations.

Although the cavity 202 is formed cylindrically to match the impact portion 20 in this embodiment, the cavity 202 is not limited to this; and in other embodiments, the cavity may be formed in other shapes depending on the profiles of different impact portions. The inner diameter of the cavity 202 shall be slightly greater than the circumference of the piston element 21 so that the piston element 21 is adapted to be disposed and move therein.

The transmission element 22 has a first end 220 and a second end 222 opposite to the first end 220. The first end 220 plugs into the impact portion 20 and is connected to the piston element 21, while the second end 222 is connected to the driving portion 23. The driving portion 23 may comprise a micro vibration motor or an electromagnetic vibrator for providing an intermittent impact force. The purpose of providing the intermittent impact force is so that the vibration frequency of the reciprocating motion can be affected if applying a continuous impact force; that is, only when the impact force is provided intermittently in the same direction, can a uniform vibration frequency be provided and maintained throughout the whole vibration process. The transmission element 22 is of a strip form, and is made of a flexible material such as a flexible steel wire, a fiberglass reinforced plastic, and a flexible fiberglass. The material of the transmission element 22 must have at least one of the following characteristics: a high elastic coefficient, a desirable rigidity, a low elongation, and a high tensile strength. Thereby, the transmission element 22 made of the flexible material can transmit the impact force provided by the driving portion 23 and absorb part of the vibrations transmitted back from the impact portion 20, thus, prolonging the service life of the light impact unit 2.

Another advantage of this arrangement of the present invention includes the following aspect: because the driving portion, which generates the impact force, is separately disposed instead of integrated with the impact portion, the total driven weight for the driving portion 23 to move in the reciprocating motion is lighter than that in conventional impact assemblies. Specifically, the total driven weight only includes the impact portion 20, the object undergoing testing (not shown), and the corresponding platform (not shown), therefore both the overall output energy and the amount replacement cost due to routine impact are significantly decreased.

Next, FIG. 3 illustrates the light impact unit 2 (not labeled) according to the first embodiment of the present invention when used in combination with a platform 24, four elastic elements 25 and four brackets 26 to form an impact assembly 3. Whereas, the impact portion 20 of the light impact unit 2 has an end fixed to the platform 24. When the impact portion 20 is driven by the piston element 21 to move in a reciprocating motion, the platform 24 is also driven by the impact portion 20 to move correspondingly, so that the object undergoing testing (not shown) that is placed on the platform 24 vibrates. In this way, the reliability and the assembly quality of the object can be tested and realized.

The platform of the present invention may be used in combination with at least one light impact unit, and only a single light impact unit 2 is taken as an example herein. The internal structure of the light impact unit 2 has already been described above, so no further descriptions will be made thereon again. The brackets 26 are disposed on a side of the platform 24, and four independent brackets 26 are used in this embodiment. Each of the brackets 26 is used in combination with one elastic element 25, and via the elastic element 25 the bracket 26 is connected to the platform 24. In detail, each of the four elastic elements 25 has an end connected to the platform 24 with the other end connected to the corresponding bracket 26. The elastic elements 25 may each be a spring or a flat spring and, in this embodiment, the elastic elements 25 are exemplified as springs. The main function of the elastic elements 25 is to support the platform 24, and act as buffer during the impacting and vibrating process. Therefore, during the impacting process, the elastic element 25 can support the platform 24 and enable the platform 24 to move in a reciprocating motion along with the light impact unit 2.

Furthermore, the driving portion 23 in this embodiment is fixed on a plane, e.g., ground, at a second included angle θ₂. The second included angle θ₂ may be the same as the first included angle θ₁ so that the transmission element 22 can transmit the impact force provided by the driving portion 23 to the impact portion 20 with a high efficiency. The second included angle θ₂ could range between 0 degree and 180 degrees. The driving portion 23 has a screw hole 231 and can be combined with another plane with a screw, which can decrease the damage to the driving portion 23 during the reciprocating motion. The driving portion 23 which comprises a vibrator (or a motor) is liable to damage after a long period and a great number of vibrations. When the impact portion 20 and the driving portion 23 are separately disposed, the impact force is only transmitted through the transmission element 22, thus, limiting the amount of feedback vibrations traveling to the driving portion 23; consequently, the damage to the driving portion 23 is decreased.

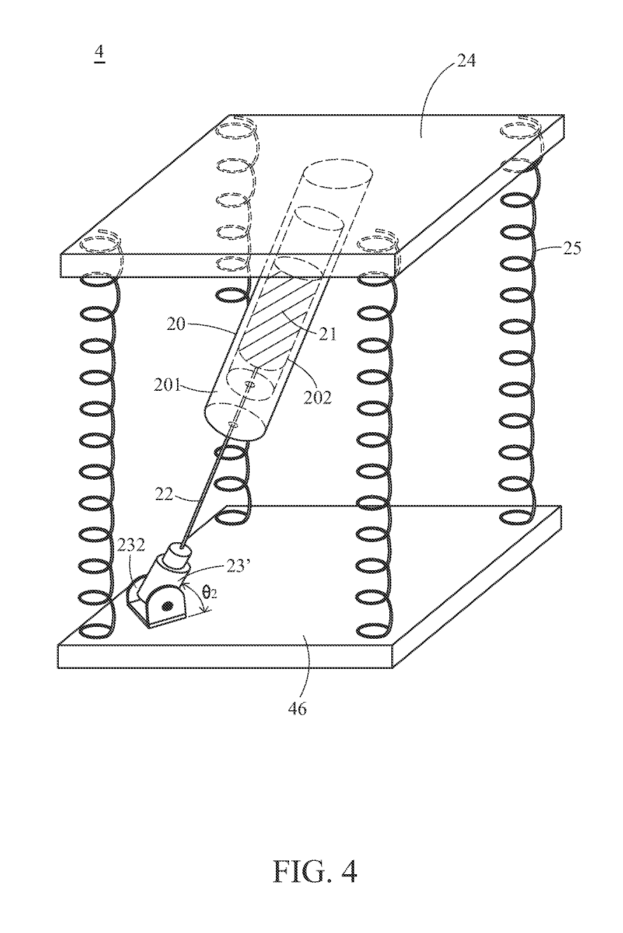

Next, with references to FIGS. 4 to 6, a schematic view of an impact assembly 4 according to a second embodiment, a schematic view of an impact assembly 5 according to a third embodiment, and a schematic view of an impact assembly 6 according to a fourth embodiment of the present invention are shown therein respectively. For the impact assemblies according to the three embodiments, only the differences from the impact assembly 1 of the first embodiment will be described hereinbelow; the other elements and the arrangement relationships therebetween are similar to what has been described above and, thus, will not be further described again.

The impact assembly 4 of the second embodiment further comprises an angle-adjustable holder 232, and a driving portion 23′ of the light impact unit 2 is disposed on a single bracket 46 via the angle-adjustable holder 232. Specifically, the driving portion 23′ can be rotated within a feasible angle range to adjust the second included angle θ₂. That is, the driving portion 23′ is rotatably mounted on the angle-adjustable holder 232. Therefore, the driving portion 23′ of this embodiment is different from a driving portion 23 that has a fixed-angle second included angle θ₂ as shown in the aforesaid embodiment, and in this embodiment the angles of the driving portion 23′ and transmission element 22 can be feasibly adjusted with respect to the impact portion 20. Furthermore, disposing the driving portion 23′ on the single bracket has the following advantage: this arrangement can provide an impact assembly that is easy to carry and can also achieve the purpose of decreasing the damage to the driving portion 23.

In the first and the second embodiments, the light impact unit 2 and the elastic elements 25 are disposed on the same side of the platform 24; however, in the third and the fourth embodiments described hereinbelow, the light impact unit 2 and the elastic elements 25 are disposed on different sides of the platform 24.

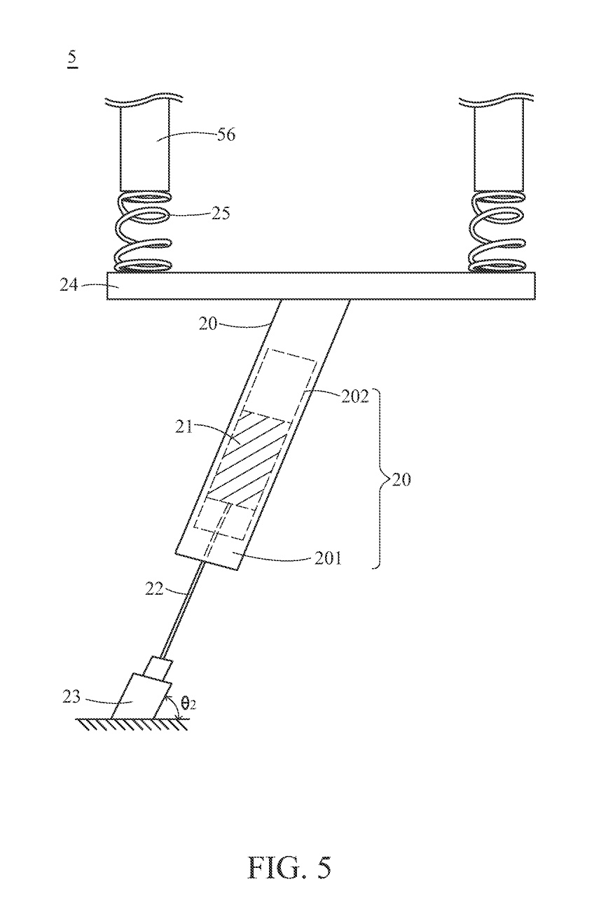

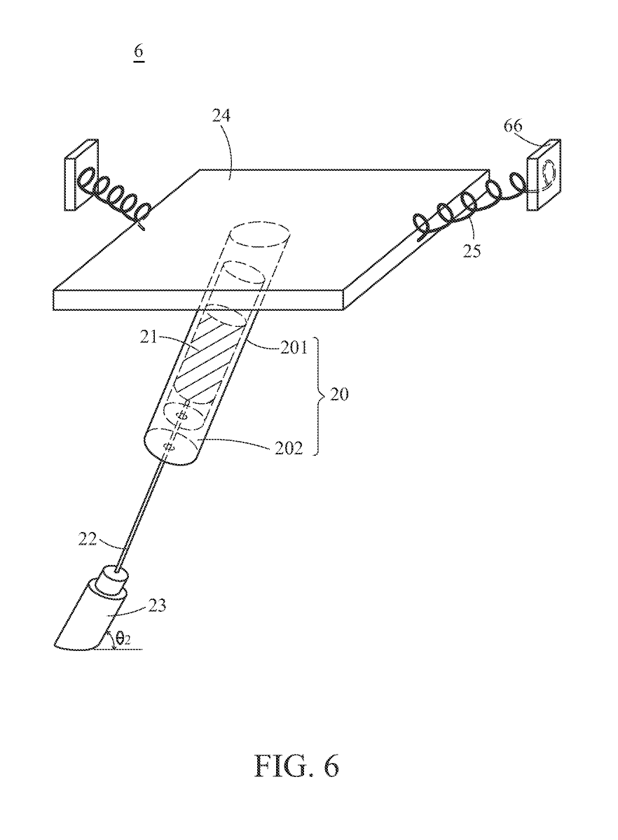

First, in reference to FIG. 5, which depicts the impact assembly 5 according to the third embodiment of the present invention, the platform 24 and the impact portion 20 fixed thereto are supported from brackets 56 by means of four elastic elements 25. The driving portion 23 is disposed on a ground. Next, with reference to FIG. 6, the brackets 66 in the impact assembly 6 according to the fourth embodiment of the present invention are disposed obliquely above the platform 24 for the following reason. If the light impact unit 2 provides the impact force to the platform 24 at a greater angle (e.g., an angle greater than 45 degrees), upright elastic elements 25 would ruin or disturb the reciprocating motion. Therefore, the brackets 66 in this embodiment are disposed obliquely above the platform 24 to avoid influence of the elastic elements 25 on the reciprocating motion when involving a greater angle.

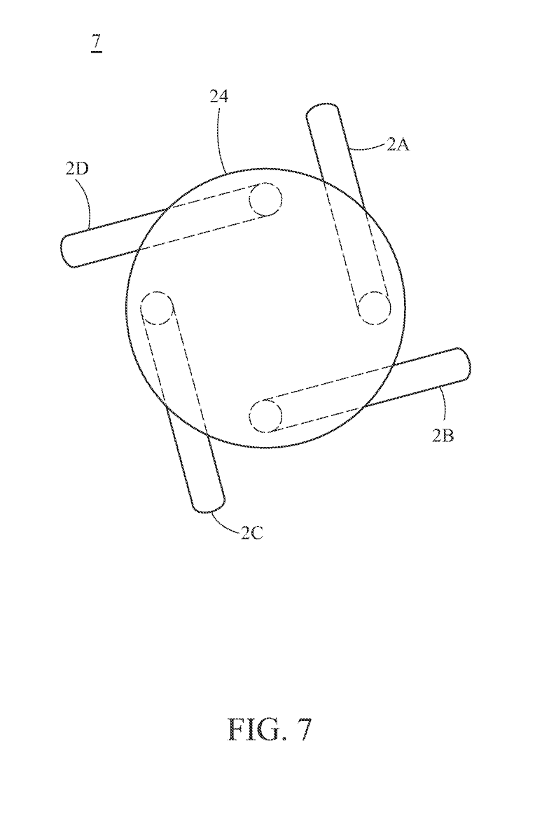

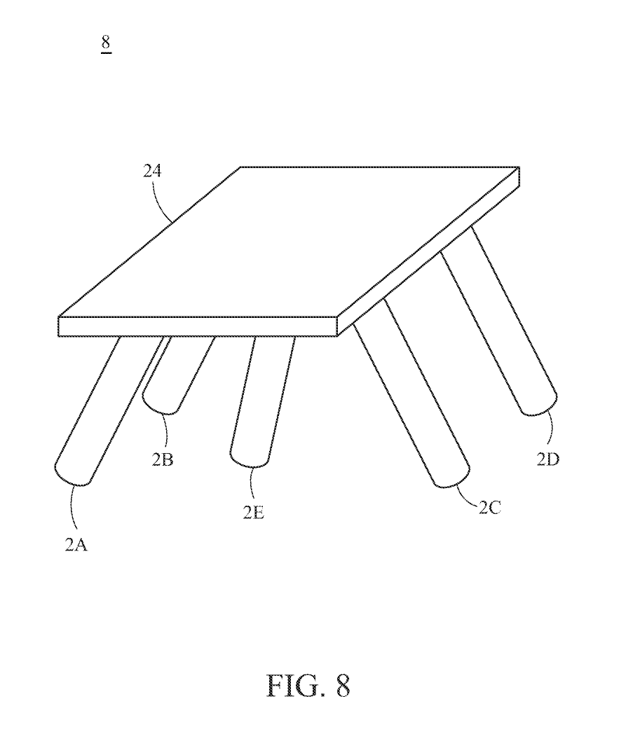

Finally, with reference to FIGS. 7 and 8, although a light impact unit 2 is used in combination with a platform 24 in all the aforesaid embodiments, the light impact unit 2 may also be used in a modular form in combination with the platform 24 to provide component forces in different directions. For the convenience of description, only the impact portion of the light impact unit is shown in the following drawings while the piston element, the transmission element and the driving portion are not shown.

First, using the impact assembly 7 of an embodiment shown in FIG. 7 as an example, the four light impact units 2A, 2B, 2C and 2D as described in the first embodiment are disposed below the platform 24 symmetrically, and each of the light impact units includes the same angle with the platform 24. Therefore, each of the light impact units can not only provide an upward component force but also provide a twisting force.

Next, with reference to FIG. 8, in addition to the light impact units 2A, 2B, 2C and 2D disposed symmetrically, an additional light impact unit 2E is further disposed vertically at the center of the lower surface of the platform 24. In practical applications, the angles and the numbers of the light impact units 2 may be determined by the user depending on different needs. The light impact units 2 are not limited to be disposed symmetrically.

According to the above descriptions, the present invention provides a design in which the driving portion and the impact portion of the impact unit are disposed separately. Because the impulse from the piston element inside the driving portion acts directly upon the testing platform or the object undergoing testing, the effective impact force applied to the object undergoing testing is increased, which makes it easier to detect flaws inside the object/product. Furthermore, this design can decrease the damage to the driving portion caused by the impact force during the reciprocating motion, and reduce the impact force that needs to be provided by the driving portion. Thereby, the objectives of prolonging the service life of the light impact unit and lowering the product cost of the present invention can be achieved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A light impact unit for an impact assembly, comprising:
an impact portion, having a cavity;
a piston element, being disposed in the cavity;
a transmission element, having a first end and a second end opposite to the first end, wherein the first end is connected to the piston element; and
a driving portion, connecting to the second end of the transmission element and providing an impact force intermittently through the transmission element to the piston element, wherein the piston element makes the impact portion move in a reciprocating motion.

2. The light impact unit as claimed in claim 1, wherein the impact portion comprises a first inclined surface and a second inclined surface opposite to the first inclined surface, and the first inclined surface and the second inclined surface are placed at two ends of the cavity respectively and extend to define a first included angle, which ranges between 0 degree and 90 degrees.

3. The light impact unit as claimed in claim 1, wherein the driving portion is a micro vibration motor.

4. The light impact unit as claimed in claim 1, wherein the driving portion is an electromagnetic vibrator.

5. The light impact unit as claimed in claim 1, wherein the transmission element is a flexible steel wire, a fiberglass reinforced plastic or a flexible fiberglass.

6. The light impact unit as claimed in claim 1, further comprising an angle-adjustable holder, wherein the driving portion is mounted on the angle-adjustable holder and functions within the adjustable angle range.

7. An impact assembly, comprising:
a platform;
a bracket, being disposed near the platform;
at least two elastic elements, wherein one end of each of the elastic elements is connected to the platform, and the other end is connected to the bracket; and
at least one light impact unit as claimed in any of claims 1 to 6, wherein the impact portion is fixed on the platform, and while the impact portion moves in the reciprocating motion under the action of the impact force, the platform is synchronously driven by the impact portion to move in the reciprocating motion.

8. The impact assembly as claimed in claim 7, wherein the driving portion is fixed to the bracket.

9. The impact assembly as claimed in claim 7, wherein the driving portion is fixed on a ground.

10. The impact assembly as claimed in claim 7, wherein each of the elastic elements is a spring or a flat spring.

11. The impact assembly as claimed in claim 7, wherein the driving portion and the platform define a second included angle, which ranges between 0 degree and 180 degrees.
